(19) United States
(12) Patent Application Publication
(10) Pub. No.: US 2008/0055335 A1
(43) Pub. Date: Mar. 6, 2008

(54) Level of detail value calculating method and medium reducing power consumption, and 3-dimensional rendering system

(75) Inventors: Seok-yoon Jung, Seoul (KR); Sang-duk Kim, Seoul (KR); Woo-chan Park, Seoul (KR); Tack-don Han, Seoul (KR)

Correspondence Address: STAAS & HALSEY LLP, SUITE 700, 1201 NEW YORK AVENUE, N.W., WASHINGTON, DC, 20005, US

(73) Assignees: SAMSUNG ELECTRONICS CO., LTD., Suwon-si (KR); YONSEI UNIVERSITY INDUSTRY FOUNDATION, Seoul (KR)

(21) Appl. No.: 11/802,226

(22) Filed: May 21, 2007

(30) Foreign Application Priority Data
Aug. 29, 2006 (KR) 10-2006-0082498

(51) Int. Cl. G06T 15/10; G09G 5/00

(52) U.S. Cl. 345/609; 345/441; 345/606

(57) ABSTRACT

A system, method and medium renders an object into a 3-dimensional (3D) graphic image. The rendering system includes a polygon processing unit to calculate a plurality of LOD values of a plurality of fragments corresponding to a plurality of vertices of a predetermined polygon, among a plurality of fragments constructing the predetermined polygon, a span conversion unit to interpolate a plurality of LOD values of remaining fragments apart from the plurality of fragments corresponding to the vertices of the predetermined polygon, using the calculated LOD values, and a texture mapping unit to map one of a plurality of textures with various resolutions to a corresponding fragment of the fragments constructing the predetermined polygon, on the basis of the LOD values interpolated by the span conversion unit.

### CROSS-REFERENCE TO RELATED APPLICATIONS

This application claims the benefit of Korean Patent Application No. 10-2006-0082498, filed on Aug. 29, 2006, in the Korean Intellectual Property Office, the disclosure of which is incorporated herein in its entirety by reference.

### BACKGROUND

1. Field

One or more embodiments of the present invention relate to a system for rendering an object into a 3-dimensional (3D) graphic image, and more particularly, to a method and system for calculating Level Of Detail (LOD) values used for texture mapping in a 3D rendering process.

2. Description of the Related Art

A technique for rendering an object into a 3-dimensional (3D) graphic image includes geometry processing of the object; span conversion of deciding values of fragments in a polygon corresponding to each unit constructing the object, wherein each fragment corresponds to a pixel on a screen of a monitor, according to a light source model; texture mapping by applying a texture corresponding to a pre-stored 2-dimensional (2D) image to the object; and color blending by blending the decided values in order to decide final values of respective pixels.

FIG. 1 is a view representing fragments constructing a triangle corresponding to a conventional polygon.

By performing geometry processing on an object, the object is divided into polygons, for example, into triangles. FIG. 1 illustrates one of several triangles constructing an object. Specifically, each unit constructing the triangle is called a “fragment”. The fragment corresponds to a pixel on a screen of a monitor. In a 3D rendering process, a value of a fragment is not a value of a pixel. However, by successively processing values of fragments using 3D rendering, the fragment values will eventually become pixel values. Also, in FIG. 1, a span means a horizontal group of fragments whose ends correspond to two edges of a triangle respectively, and is a processing unit in the span conversion described above.

In texture mapping based on a Mipmap method, a Level Of Detail (LOD) value representing a degree of fineness in object representation is calculated with respect to each fragment constructing a triangle, using the following Equation 1, and one of several textures with various resolutions is mapped to the corresponding fragment according to the LOD value. The LOD value is generally denoted by lambda λ in Equation 1.

λ=log₂[MAX {\sqrt{(du/dx)²+(dv/dx)²}, \sqrt{(du/dy)²+(dv/dy)²}, }] Equation 1:

As seen in Equation 1, the conventional LOD value calculating scheme requires multiplication operations and division operations, and accordingly, consumes a large amount of power.

### SUMMARY

One or more embodiments of the present invention provide a method and system capable of reducing the number of calculations required when using a 3-dimensional (3D) rendering system for calculating a Level Of Detail (LOD) value with respect to each fragment constructing a polygon, thereby reducing power consumption of the 3D rendering system.

One or more embodiments of the present invention also provide a computer-readable recording medium having embodied thereon a program for executing the method.

Additional aspects and/or advantages of the invention will be set forth in part in the description which follows and, in part, will be apparent from the description, or may be learned by practice of the invention.

To achieve at least the above and/or other aspects and advantages, embodiments of the present invention include a Level Of Detail (LOD) value calculating method, including, calculating a plurality of LOD values of a plurality of fragments corresponding to a plurality of vertices of a predetermined polygon, among a plurality of fragments constructing the predetermined polygon, and interpolating a plurality of LOD values of remaining fragments apart from the fragments corresponding to the vertices, using the calculated LOD values.

To achieve at least the above and/or other aspects and advantages, embodiments of the present invention include at least one medium including computer readable code to control at least one processing element in a computer to implement a method executing a Level Of Detail (LOD) value calculation, the method including, calculating a plurality of LOD values of a plurality of fragments corresponding to a plurality of vertices of a predetermined polygon, among a plurality of fragments constructing the predetermined polygon, and interpolating a plurality of LOD values of remaining fragments apart from the fragments corresponding to the vertices, using the calculated LOD values.

To achieve at least the above and/or other aspects and advantages, embodiments of the present invention include a Level Of Detail (LOD) value calculating system including, a polygon processing unit to calculate a plurality of LOD values of a plurality of fragments corresponding to a plurality of vertices of a predetermined polygon, among a plurality of fragments constructing the predetermined polygon, an edge processing unit to calculate a plurality of LOD values of a plurality of fragments corresponding to a plurality of edges of the predetermined polygon, using the LOD values calculated by the polygon processing unit, and a span processor to calculate a plurality of LOD values of a plurality of fragments constructing each span, with respect to each span constructing the predetermined polygon, using the LOD values calculated by the edge processing unit.

To achieve at least the above and/or other aspects and advantages, embodiments of the present invention include a rendering method including, calculating a plurality of LOD values of a plurality of fragments corresponding to a plurality of vertices of a predetermined polygon, among a plurality of fragments constructing the predetermined polygon, interpolating a plurality of LOD values of remaining fragments apart from the plurality of fragments corresponding to the vertices of the predetermined polygon, using the calculated LOD values, and mapping one of a plurality of textures with various resolutions to a corresponding fragment of the fragments constructing the predetermined polygon, on the basis of the interpolated LOD values.

According To achieve at least the above and/or other aspects and advantages, embodiments of the present invention include at least one medium including computer readable code to control at least one processing element in a computer to implement a rendering method including, calculating a plurality of LOD values of a plurality of fragments corresponding to a plurality of vertices of a predetermined polygon, among a plurality of fragments constructing the predetermined polygon, interpolating a plurality of LOD values of remaining fragments apart from the plurality of fragments corresponding to the vertices of the predetermined polygon, using the calculated LOD values, and mapping one of a plurality of textures with various resolutions to a corresponding fragment of the fragments constructing the predetermined polygon, on the basis of the interpolated LOD values.

To achieve at least the above and/or other aspects and advantages, embodiments of the present invention include a rendering system including, a polygon processing unit to calculate a plurality of LOD values of a plurality of fragments corresponding to a plurality of vertices of a predetermined polygon, among a plurality of fragments constructing the predetermined polygon, a span conversion unit to interpolate a plurality of LOD values of remaining fragments apart from the plurality of fragments corresponding to the vertices of the predetermined polygon, using the calculated LOD values, and a texture mapping unit to map one of a plurality of textures with various resolutions to a corresponding fragment of the fragments constructing the predetermined polygon, on the basis of the LOD values interpolated by the span conversion unit.

### BRIEF DESCRIPTION OF THE DRAWINGS

The patent or application file contains at least one drawing executed in color. Copies of this patent or patent application publication with color drawings will be provided by the Office upon request and payment of the necessary fee. These and/or other aspects and advantages of the invention will become apparent and more readily appreciated from the following description of the embodiments, taken in conjunction with the accompanying drawings of which:

FIG. 1 is a view representing fragments constructing a triangle corresponding to a conventional polygon;

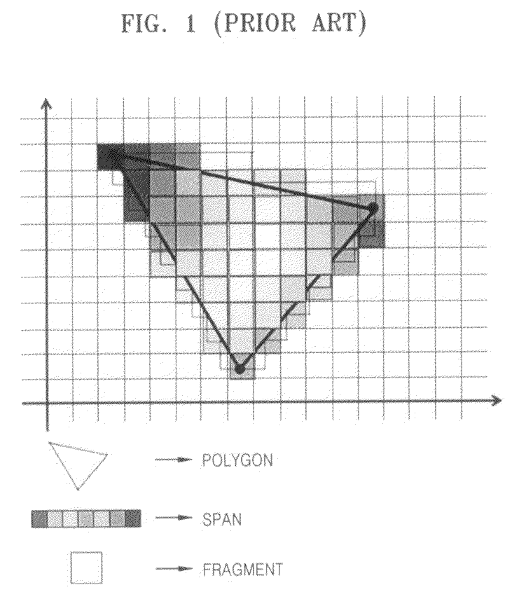

FIG. 2 is illustrates a rasterizer, according to an embodiment of the present invention;

FIG. 3 illustrates a span conversion unit, such as illustrated in FIG. 2, according to an embodiment of the present invention;

FIG. 4 illustrates a 3-dimensional (3D) rendering method, according to an embodiment of the present invention;

FIG. 5 illustrates a span conversion method, according to an embodiment of the present invention;

FIG. 6 illustrates the total number of calculations performed according to a conventional Level Of Detail (LOD) value calculation scheme;

FIG. 7 illustrates the total number of calculations performed according to another conventional LOD value calculation scheme;

FIG. 8 illustrates the total number of calculations performed in an LOD value calculation method, according to an embodiment of the present invention,

FIG. 9 compares the total number of calculations performed, according to the conventional LOD value calculation scheme illustrated in FIG. 7 with the total number of calculations performed in the LOD value calculation method, according to an embodiment of the present invention; and

FIG. 10 illustrates the number of calculation scheme performed when the number of fragments is 25, where the number of calculations is calculated using the comparison table illustrated in FIG. 9.

### DETAILED DESCRIPTION OF EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

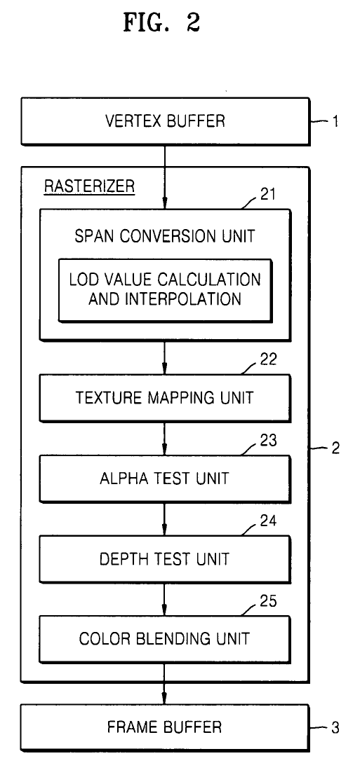

FIG. 2 illustrates a rasterizer 2, according to an embodiment of the present invention.

Referring to FIG. 2, the rasterizer 2 may include, for example, a span conversion unit 21, a texture mapping unit 22, an alpha test unit 23, a depth test unit 24, and a color blending unit 25. The rasterizer 2 is a component which is generally used in a 3-dimensional (3D) rendering system for rendering an object on a screen of a monitor into a 3D graphic image. The rasterizer 2 may determine values of pixels that are to appear on the screen.

Before processing of the rasterizer 2, geometry processing typically should be performed. In geometry processing, the object may be divided into a number of polygons, and parameter values of fragments constructing each polygon may be respectively determined. The parameter values of the fragments may form fragment unit information for rendering the object divided into polygons into a 3-dimensional graphic image. Each parameter value may include, for example, a depth value (z) and a color value (r, g, b, a) of the corresponding fragment, a coordinate value (s, t) of a texture that is to be mapped to the corresponding fragment, etc. Here, “r” may represent red, “g” may represent green, “b” may represent blue, and “a” may represent information indicating whether the corresponding fragment is transparent. Also, “s” and “t” may represent normalized coordinate values (e.g., from 0 to 1) of the texture.

Generally, in order to reduce the number of rendering calculations, a triangle, which is the simplest form among various forms of polygons, may be used. Hereinafter, an embodiment will be described based on the assumption that the polygon is a triangle. However, it will be understood by one of ordinary skill in the art that other forms of polygons apart from a triangle may equally be applied to embodiments of the present invention.

The span conversion unit 21 may decide the parameter values of the fragments constructing the triangle. In more detail, the span conversion unit 21 may receive coordinate values of three vertices of the triangle, from among the fragments constructing the triangle, from a vertex buffer 1, and may calculate parameter values of fragments corresponding to the three vertices of the triangle, using Equation 1. Also, the span conversion unit 21 may interpolate parameter values of the remaining fragments apart from the fragments corresponding to the vertices of the triangle, from the parameter values of the fragments corresponding to the vertices.

In particular, according to an embodiment, the span conversion unit 21 may calculate Level Of Detail (LOD) values of the fragments corresponding to the three vertices of the triangle, from among the fragments constructing the triangle, and interpolate LOD values of the remaining fragments apart from the fragments corresponding to the vertices of the triangle, from the LOD values of the fragments corresponding to the vertices, using a scheme similar to a conventional parameter value interpolation scheme. That is, the span conversion unit 21 may calculate LOD value gradients of the fragments corresponding to the three vertices of the triangle, according to the conventional parameter value interpolation scheme, and interpolate LOD values of the remaining fragments, using the LOD value gradients. As such, the span conversion unit 21 may calculate LOD values as well as parameter values, in contrast with conventional span conversion methods. Conventionally, LOD values have been calculated in a texture mapping process.

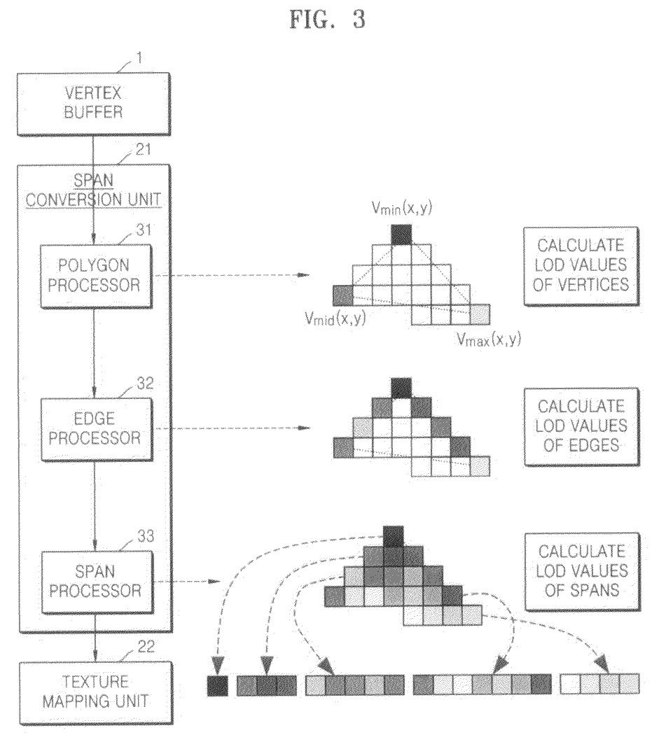

FIG. 3 illustrates the span conversion unit 21 illustrated in FIG. 2.

Referring to FIGS. 2 and 3, the span conversion unit 21 may include, for example, a polygon processor 31, an edge processor 32, and a span processor 33.

The polygon processor 31 may calculate parameter value gradients on an x-axis of the triangle and parameter value gradients on a y-axis of the triangle, from the parameter values of the fragments corresponding to the three vertices of the triangle, with respect to two edges starting from a vertex whose y coordinate value is the minimum, from among three edges of the triangle. Particularly, according to the current embodiment, the polygon processor 31 may calculate LOD values of the fragments, using a scheme similar to a conventional parameter polygon processing scheme. That is, the polygon processor 31 may calculate LOD values of the fragments corresponding to the three vertices of the triangle, among the fragments constructing the triangle, and calculate LOD value gradients on the x-axis of the triangle and LOD value gradients on the y-axis of the triangle, from the LOD values of the fragments corresponding to the three vertices of the triangle, with respect to two edges starting from a vertex whose y coordinate value is the minimum, from among three edges of the triangle.

For example, the polygon processor 31 may calculate the LOD value gradients on the x-axis of the triangle, and the LOD value gradients on the y-axis of the triangle, using the following Equations 2.

Emaj_{—}dλ=Vmax−Vmin;

Ebot_{—}dλ=Vmid−Vmin;

dλ/dx=(Emaj_{—}dλ*Ebot_{—}dy−Emaj_{—}dy*Ebot_{—}dλ)/(Emaj_{—}dx*Ebot_{—}dy−Emaj_{—}dy*Ebot_{—}dx);

dλ/dy=(Emaj_{—}dx*Ebot_{—}dλ−Emaj_{—}dλ*Ebot_{—}dx)/(Emaj_{—}dx*Ebot_{—}dy−Emaj_{—}dy*Ebot_{—}dx); Equation 2:

In this example, the number of addition, subtraction, multiplication and division (+, −, *, /) calculations performed may be (0, 4, 4, 0), respectively. In the equations 2, “Vmax” represents an LOD value of a vertex whose y coordinate value may be the maximum, “Vmid” represents an LOD value of a vertex whose y coordinate value may be in the middle, and “Vmin” represents an LOD value of a vertex whose y coordinate value may be the minimum. Also, “dλ/dx” represents the LOD value gradients on the x-axis of the triangle, and “dλ/dy” represents the LOD value gradients on the y-axis of the triangle.

The edge processor 32 may calculate parameter values of fragments corresponding to the two edges of the triangle, using the parameter value gradients on the x-axis and the parameter value gradients on the y-axis calculated by the polygon processor 31, with respect to each span constructing the triangle, and may calculate parameter value differences between fragments constructing the span. Here, the span may refer to a horizontal group of fragments whose ends correspond to two edges of the triangle.

Particularly, according to an embodiment, the edge processor 32 may calculate LOD values of the fragments corresponding to the two edges of the triangle, using a scheme similar to a conventional parameter edge processing scheme, and may calculate LOD value differences between fragments constructing each span. That is, the edge processor 32 may calculate LOD values of fragments corresponding to the two edges of the polygon, for example, using the LOD value gradients on the x-axis and the LOD value gradients on the y-axis calculated by the polygon processor 31, with respect to each span constructing the triangle, and may calculate LOD value differences between the fragments constructing each span.

For example, in an embodiment, the edge processor 32 may calculate the LOD values of the fragments corresponding to the two edges of the triangle, and may calculate the LOD value differences between the fragments constructing each span, using the following Equations 3.
With respect to each of spans constructing a triangle,

{Compare;

fλ=λ0+adjx*dλ/dx+adjy*dλ/dy;

fdλOuter=dλ/dy+fdxOuter*dλ/dx;}

fdλInner=fdλOuter+dλ/dx; Equations 3:

In the example, when edges are processed, the number of (+, −, *, /) calculations performed may equal “the number of spans*{(3, 0, 3, 0)+compare}+(1, 0, 0, 0)”, respectively. Here, “compare” may be a comparison operation for selecting one from among the three edges of the triangle. By using the comparison operation, one of Vmin, Vmid, and Vmax may be selected as a start vertex for interpolating the LOD values of the fragments. “λ0” represents an LOD value of the start vertex selected by the “compare” operation. Also, “adjx” represents a difference between a center coordinate value of the fragment corresponding to the start vertex with respect to the x-axis, and an actual coordinate value of the start vertex. Also, “adjy” represents a difference between a center coordinate value of the fragment corresponding to the start vertex with respect to the y-axis, and an actual coordinate value of the start vertex. Accordingly, “fλ” may become an LOD value of the center of the fragment corresponding to the start vertex. This process may be performed so as to separately calculate an LOD value of the center of the fragment corresponding to the start vertex, considering the fact that the actual coordinates of the start vertex may not be located on the exact center of the corresponding fragment. Also, “fdxOuter” represents a gradient dx/dy of an edge which is currently being calculated. Accordingly, “fdλOuter” may become 2*dλ/dy and “fdλInner” may become 2*dλ/dy+dλ/dx. These two values may be used for the following span processing, when an LOD value calculation for a span which is currently being calculated is terminated and an LOD value calculation for a different span is started.

The span processor 33 may calculate parameter values of fragments constructing each span, using, for example, differences between the parameter values of the fragments corresponding to the edges calculated by the edge processor 32 and the parameter values of the fragments constructing each span, with respect to each span constructing the triangle.

In particular, according to an embodiment, the span processor 33 may calculate LOD values of fragments constructing each span, using a scheme similar to a conventional parameter span processing scheme. That is, the span processor 33 may calculate LOD values of the fragments constructing each span, using LOD values of fragments corresponding to edges calculated by the edge processor 32, and LOD value differences between the fragments constructing each span, with respect to each span constructing the triangle.

For example, the span processor 33 may calculate LOD values of fragments constructing each span, by performing two processes, e.g., a first process and a second process. The first process may be performed when an LOD value calculation proceeds from a current span to a following span, and the second process may be performed on each span constructing a triangle.

When the LOD value calculation proceeds from the current span to the following span, Equations 4 may be used.

{ffλend=fdλ+(Right−Left−1)*dλ/dx;

fλ=fλ+fdλOuter or fλ=fλ+fdλInner;

fλ=fλ−ffλend;}
with respect to each span constructing a triangle,

{fλ=fλ+dλ/dx} Equations 4:

In the above example, the number of (+, −, *, /) calculations performed for span processing may equal {the number of spans*(3, 0, 1, 0)+the number of fragments*(1, 0, 0, 0)”}, respectively. In Equations 4, “Right-Left” represents the total number of fragments constructing the current span. Accordingly, “ffλend” becomes an LOD value of a final fragment among the fragments constructing the current span. Determination as to which one of “fdλOuter” and “fdλInner” to “fλ” should be added depends on which one of “fdλOuter” and “fdλInner” is greater than the remaining one. That is, whichever of an LOD value gradient on the x-axis and an LOD value gradient on the y-axis is greater than the remaining one may be determined by comparing the two values “fdλOuter” and “fdλInner” with each other. If the LOD value gradient on the x-axis is greater than the LOD value gradient on the y-axis, “fdλOuter” may be added to “fλ”. If the LOD value gradient on the y-axis is greater than the LOD value gradient on the x-axis, “fdλInner” may be added to “fλ”. By this selective adding process, an LOD value “fλ” of a fragment corresponding to an edge of the following span may be calculated. The operation of “fλ=fλ−ffλend” may be performed when the value “fλ” overflows, that is, when the value “fλ” exceeds predetermined bits assigned to the LOD value.

The second process may be performed in order to calculate LOD values of fragments constructing a span by adding “dλ/dx” corresponding to a unit gradient to “fλ” while increasing a y value by one. The second process may be easily implemented by one of ordinary skill in the art.

The texture mapping unit 22 may map one of a number of textures with various resolutions to the corresponding fragment, on the basis of the LOD values of the fragments calculated or interpolated by the span conversion unit 21, according to a Mipmap method, for example. In more detail, if an LOD value of a fragment is increasing, the texture mapping unit 22 may map a texture with a higher resolution from among the textures with various resolutions to the corresponding fragment. If an LOD value of a fragment is decreasing, the texture mapping unit 22 maps a texture with a lower resolution from among the textures with various resolutions to the corresponding fragment. By performing this texture mapping process, an image corresponding to the texture may be applied to an object.

The alpha test unit 23 may compare an alpha value a from among the parameter values of the fragments calculated or interpolated by the span conversion unit 21, with a predetermined reference value, and determine whether the respective fragments are transparent, according to the comparison result.

If a depth value z from among the parameter values of the fragments calculated or interpolated by the span conversion unit 21 is smaller than a depth value stored in a depth buffer (not shown), the depth test unit 24 may update the depth value stored in the depth buffer to the depth value z.

The color blending unit 25 may blend the parameter values of the fragments calculated or interpolated by the span conversion unit 21, with color values stored in a pixel buffer (not shown), thereby outputting final values of pixels on a screen corresponding to the fragments. In particular, the color blending unit 25 may output the texture mapped by the texture mapping unit 22, the transparency determination results determined by the alpha test unit 23, and final values of pixels in which depth values updated by the depth test unit 24 are reflected, to a frame buffer 3.

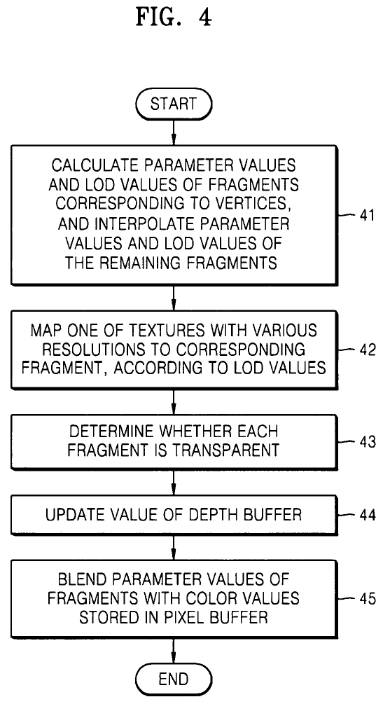

FIG. 4 illustrates a 3D rendering method, according to an embodiment of the present invention.

In operation 41, coordinate values of three vertices of a triangle may be received, e.g., by the rasterizer 2, among fragments constructing the triangle, from a vertex buffer 1, and parameter values and LOD values of fragments corresponding to the three vertices of the triangle, may be calculated using, for example, Equation 1. Also, in operation 41, parameter values and LOD values of the remaining fragments apart from the fragments corresponding to the three vertices of the triangle may be interpolated, from among the parameter values and LOD values of the three vertices.

In operation 42, one of a number of textures with various resolutions may be mapped to the corresponding fragment, on the basis of the respective LOD values of the fragments calculated or interpolated in operation 41, according to, for example, the Mipmap method.

In operation 43, an alpha value a of the parameter values of the fragments calculated or interpolated in operation 41, may be compared with a predetermined value, and the comparison result may be used to determine whether the respective fragments are transparent.

In operation 44, if a depth value z from among the parameter values of the fragments calculated or interpolated in operation 41 is smaller than a depth value stored in the depth buffer, the depth value of the depth buffer may be updated to the depth value z.

In operation 45, the respective parameter values of the fragments calculated or interpolated in operation 41 may be blended with color values stored in the pixel buffer, thereby outputting the texture mapped in operation 42, the transparency determination result determined in operation 43, and final values of pixels in which depth values updated in operation 44 are reflected, to the frame buffer 3.

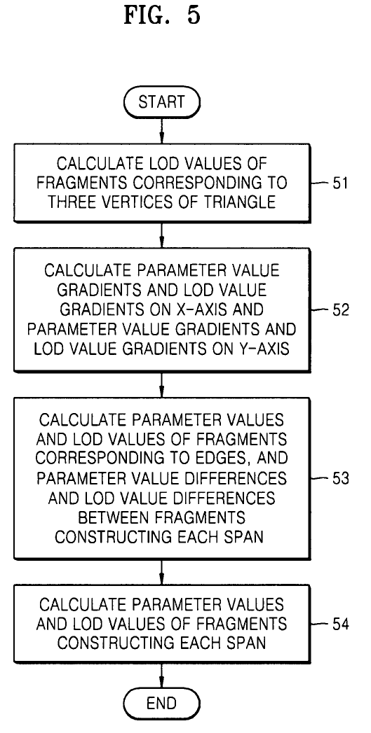

FIG. 5 illustrates a span conversion method, according to an embodiment of the present invention.

In operation 51, LOD values of fragments corresponding to three vertices of a triangle, may be calculated, e.g., by the span conversion unit 21, from among fragments constructing the triangle.

In operation 52, parameter value gradients and LOD value gradients on an x-axis of the triangle and parameter value gradients and LOD value gradients on a y-axis of the triangle may be calculated, from parameter values and LOD values of the fragments corresponding to three vertices of the triangle, with respect to two edges starting from a vertex whose y coordinate value is the minimum, from among three edges of the triangle.

In operation 53, parameter values and LOD values of fragments corresponding to the two edges of the triangle, may be calculated using the parameter value gradients and LOD value gradients on the x-axis and the parameter value gradients and LOD value gradients on the y-axis calculated in operation 52, with respect to each span constructing the triangle, and then parameter value differences and LOD value differences between fragments constructing each span may be calculated.

In operation 54, parameter values and LOD values of fragments constructing each span may be calculated, using the parameter values and LOD values of the fragments corresponding to the edges calculated in operation 53, and the parameter value differences and LOD value differences between the fragments constructing each span may be calculated, with respect to each span constructing the triangle.

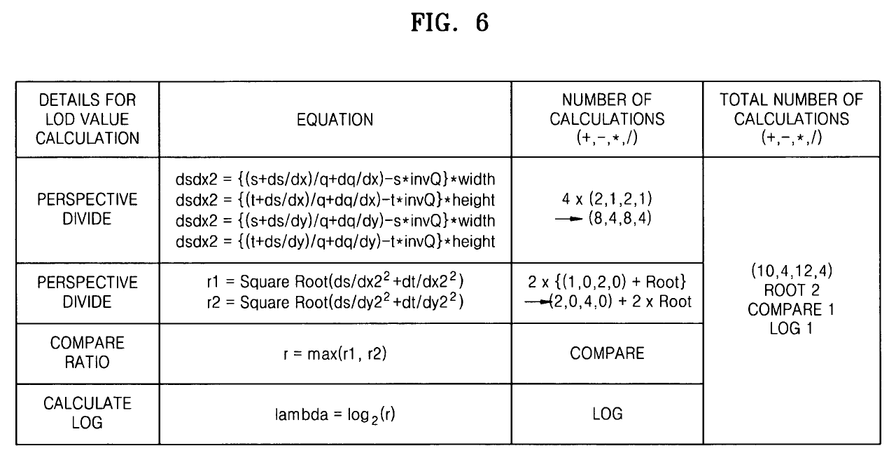

FIG. 6 illustrates the total number of calculations performed according to a conventional LOD value calculation scheme.

In FIG. 6, “s” and “t” represent normalized coordinate values (e.g., from “0” to “1”) of a texture. Also, “q” represents correction data according to distance, and “invQ” is 1/q. Also, “width” and “height” represent the horizontal size and vertical size of the texture, respectively.

Referring to FIG. 6, the total number of calculations performed according to the conventional LOD value calculation scheme is “the number of fragments constructing a triangle*{(10, 4, 12, 4), square root operations twice, a comparison operation once, a log operation once)”. Here, (10, 4, 12, 4) represent the number of (+, −, *, /) calculations performed, respectively, for each fragment.

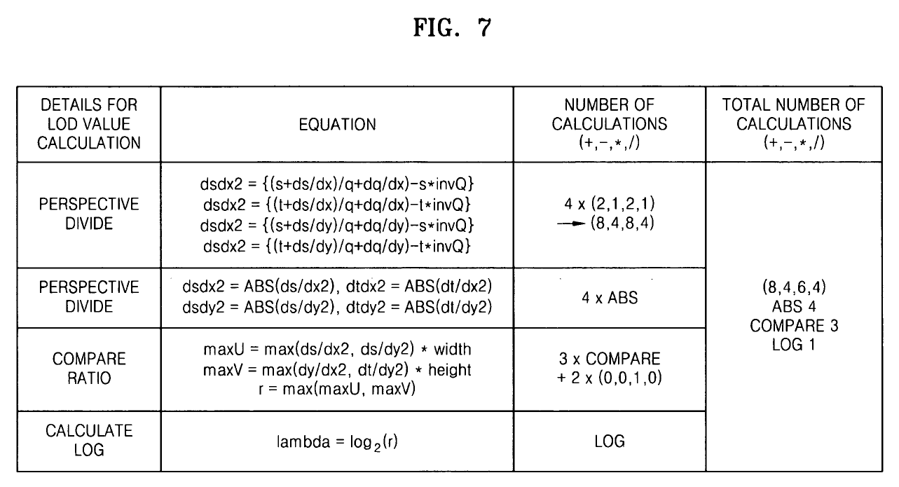

FIG. 7 illustrates the total number of calculations performed according to another conventional LOD value calculation scheme.

Referring to FIG. 7, the total number of calculations according to the conventional LOD value calculation scheme is “the number of fragments constructing a triangle*{(8, 4, 6, 4), ABS (“Absolute value”) operations 4 times, comparison operations 3 times, a log operation once)”. Here, (8, 4, 6, 4) represents the number of (+, −, *, /) calculations performed, respectively, for each fragment.

Comparing the conventional LOD value calculation scheme illustrated in FIG. 6 with the conventional LOD value calculation scheme illustrated in FIG. 7, the number of calculations performed according to the conventional LOD value calculation scheme illustrated in FIG. 7 is smaller than the number of calculations performed according to the conventional LOD value calculation scheme illustrated in FIG. 6. Accordingly, the number of calculations according to the conventional LOD value calculation technique illustrated in FIG. 7 will be compared with the number of calculations according to an LOD value calculation method, according to an embodiment of the present invention, below.

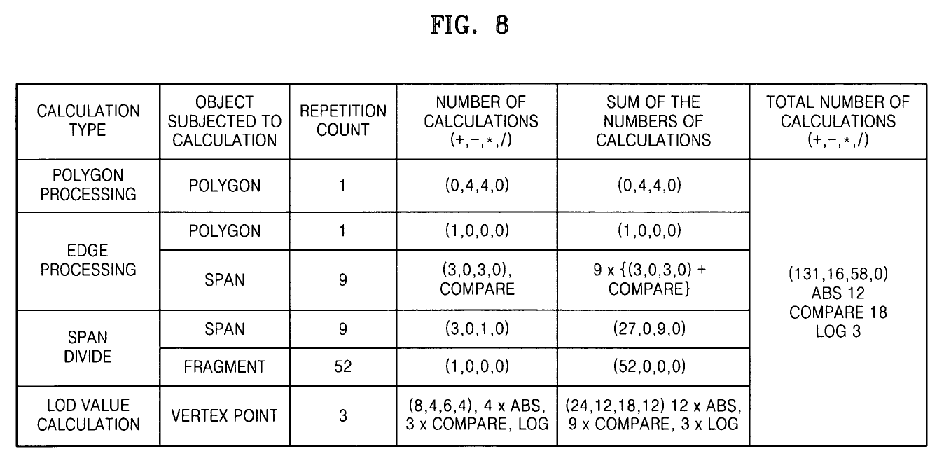

FIG. 8 illustrates the total number of calculations performed in an LOD value calculation method, according to an embodiment of the present invention.

Referring to FIG. 8, the total number of calculations according to the LOD value calculation method of the current embodiment may be a sum of the numbers of calculations required for polygon processing, edge processing, and span processing as described above, and may be, in this example, “{(87, 3, 13, 0), ABS operations 12 times, comparison operations 11 times, and log operations 3 times)”. In FIG. 8, (8, 4, 6, 4) represents the number of (+, −, *, /) calculations performed for each fragment, respectively. The total number of calculations shown in FIG. 8 may be obtained based on the assumption that the number of fragments is 52.

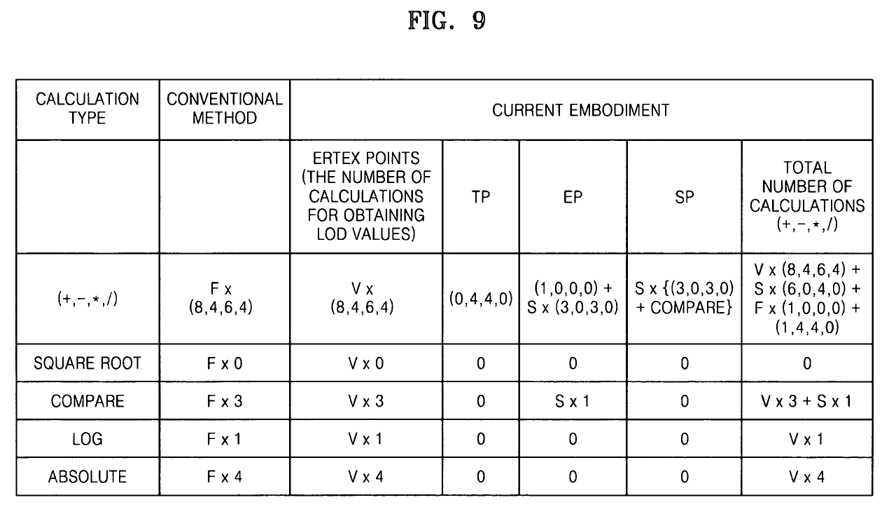

FIG. 9 compares the number of calculations performed according to the conventional LOD value calculation scheme illustrated in FIG. 7 with the number of calculations performed in the LOD value calculation method, according to an embodiment of the present invention.

In FIG. 9, “V” represents the number of vertices constructing a polygon, “F” represents the number of fragments constructing the polygon, and “S” represents the number of spans constructing the polygon.

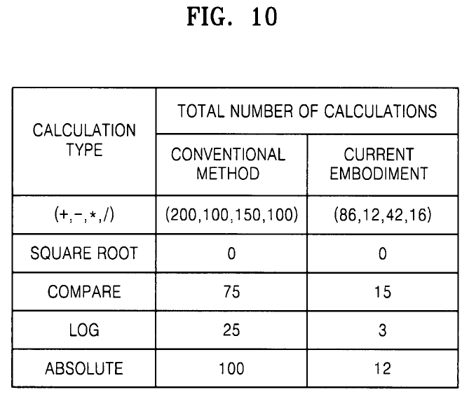

FIG. 10 illustrates the total number of calculations performed when the number of fragments is 25, as an example, where the number of calculations is calculated using the comparison table illustrated in FIG. 9.

In an embodiment, if it is assumed that the number “F” of fragments is 25 in the comparison table illustrated in FIG. 9, then the total number of calculations performed according to the conventional LOD value calculation scheme is “{(200, 100, 150, 100), comparison operations 75 times, log operations 25 times, and ABS operations 100 times}”. Also, if it is assumed that the number “V” of vertices is 3, the number “S” of spans is 6, and the number “F” of fragments is 25 in the comparison table illustrated in FIG. 9, then the total number of calculations performed in the LOD value calculation method, according to the current embodiment is “{(86, 12, 42, 16), comparison operations 15 times, log operations 3 times, and ABS operations 12 times}”. Accordingly, the number of calculations according to the LOD value calculation method, according to the current embodiment may be significantly smaller than the number of calculations according to the conventional LOD value calculation scheme.

In addition to the above described embodiments, embodiments of the present invention may also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code may be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

As described above, according to one or more embodiments of the present invention, by calculating LOD values of fragments corresponding to vertices of a polygon and interpolating LOD values of the remaining fragments from the LOD values of the fragments corresponding to the vertices of the polygon, it may be possible to significantly reduce the number of calculations required for obtaining LOD values, and accordingly reduce power consumption in a 3D rendering system. In particular, according to one or more embodiments of the present invention, by interpolating LOD values using a scheme similar to the conventional parameter value interpolation scheme, it may be possible to minimize the number of circuit devices required for calculating LOD values.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A Level Of Detail (LOD) value calculating method, comprising:
calculating a plurality of LOD values of a plurality of fragments corresponding to a plurality of vertices of a predetermined polygon, among a plurality of fragments constructing the predetermined polygon; and
interpolating a plurality of LOD values of remaining fragments apart from the fragments corresponding to the vertices, using the calculated LOD values.

2. The method of claim 1, wherein, in the interpolating of the plurality of LOD values, a plurality of gradients of the LOD values of the fragments corresponding to the vertices are calculated, and the LOD values of the remaining fragments are interpolated, using the gradients of the calculated LOD values.

3. The method of claim 1, wherein, in the interpolating of the plurality of LOD values, the LOD values are interpolated using a same scheme as the scheme for interpolating a plurality of parameter values of a plurality of fragments corresponding to information for rendering an object divided into a plurality of predetermined polygon units.

4. The method of claim 3, wherein each parameter value comprises a coordinate value and a color value of each of the fragments constructing the predetermined polygon, and a coordinate value of a texture that is to be mapped to each of the fragments.

5. The method of claim 1, wherein the interpolating of the plurality of LOD values comprises:
calculating a plurality of LOD value gradients on an x-axis of the polygon and a plurality of LOD value gradients on a y-axis of the polygon, from among the LOD values of the fragments corresponding to the vertices;
calculating a plurality of LOD values of a plurality of fragments corresponding to a plurality of edges of the polygon, using the LOD value gradients on the x-axis of the polygon and the LOD value gradients on the y-axis of the polygon; and
calculating a plurality of LOD values of a plurality of fragments constructing each span, with respect to each span constructing the predetermined polygon, using the LOD values of the fragments corresponding to the edges of the polygon.

6. At least one medium comprising computer readable code to control at least one processing element in a computer to implement a method executing a Level Of Detail (LOD) value calculation, the method comprising:
calculating a plurality of LOD values of a plurality of fragments corresponding to a plurality of vertices of a predetermined polygon, among a plurality of fragments constructing the predetermined polygon; and
interpolating a plurality of LOD values of remaining fragments apart from the fragments corresponding to the vertices, using the calculated LOD values.

7. A Level Of Detail (LOD) value calculating system comprising:
a polygon processing unit to calculate a plurality of LOD values of a plurality of fragments corresponding to a plurality of vertices of a predetermined polygon, among a plurality of fragments constructing the predetermined polygon;
an edge processing unit to calculate a plurality of LOD values of a plurality of fragments corresponding to a plurality of edges of the predetermined polygon, using the LOD values calculated by the polygon processing unit; and
a span processor to calculate a plurality of LOD values of a plurality of fragments constructing each span, with respect to each span constructing the predetermined polygon, using the LOD values calculated by the edge processing unit.

8. The system of claim 7, wherein the polygon processing unit calculates a parameter value and an LOD value of each fragment corresponding to each of the edges; and
the span processor calculates a parameter value and an LOD value of each fragment constructing each span.

9. The system of claim 8, wherein the parameter value comprises a coordinate value and a color value of each fragment constructing the predetermined polygon, and a coordinate value of a texture that is to be mapped to each fragment.

10. A rendering method comprising:
calculating a plurality of LOD values of a plurality of fragments corresponding to a plurality of vertices of a predetermined polygon, among a plurality of fragments constructing the predetermined polygon;
interpolating a plurality of LOD values of remaining fragments apart from the plurality of fragments corresponding to the vertices of the predetermined polygon, using the calculated LOD values; and
mapping one of a plurality of textures with various resolutions to a corresponding fragment of the fragments constructing the predetermined polygon, on the basis of the interpolated LOD values.

11. The method of claim 10, wherein, in the interpolating of the LOD values of the remaining fragments, a parameter value and an LOD value of each of the remaining fragments apart from the fragments corresponding to the vertices are interpolated, from among a plurality of parameter values and a plurality of LOD values of the fragments corresponding to the vertices.

12. The method of claim 11, wherein the parameter value comprises a coordinate value and a color value of a corresponding parameter of the fragments constructing the predetermined polygon, and a coordinate value of a texture that is to be mapped to the corresponding parameter.

13. At least one medium comprising computer readable code to control at least one processing element in a computer to implement a rendering method comprising:
calculating a plurality of LOD values of a plurality of fragments corresponding to a plurality of vertices of a predetermined polygon, among a plurality of fragments constructing the predetermined polygon;
interpolating a plurality of LOD values of remaining fragments apart from the plurality of fragments corresponding to the vertices of the predetermined polygon, using the calculated LOD values; and
mapping one of a plurality of textures with various resolutions to a corresponding fragment of the fragments constructing the predetermined polygon, on the basis of the interpolated LOD values.

14. A rendering system comprising:
a polygon processing unit to calculate a plurality of LOD values of a plurality of fragments corresponding to a plurality of vertices of a predetermined polygon, among a plurality of fragments constructing the predetermined polygon;
a span conversion unit to interpolate a plurality of LOD values of remaining fragments apart from the plurality of fragments corresponding to the vertices of the predetermined polygon, using the calculated LOD values; and
a texture mapping unit to map one of a plurality of textures with various resolutions to a corresponding fragment of the fragments constructing the predetermined polygon, on the basis of the LOD values interpolated by the span conversion unit.
